(19) United States
(12) Patent Application Publication
(10) Pub. No.: US 2011/0179710 A1
(43) Pub. Date: Jul. 28, 2011

(54) Plant Containment Device For Irrigation And Fertigation And Associated Methods

(75) Inventor: Edmund A. Sinda, Bradenton, FL (US)

(73) Assignee: DEVELOPMENTAL TECHNOLOGIES, LLC, Bradenton, FL (US)

(21) Appl. No.: 12/968,973

(22) Filed: Dec. 15, 2010

Related U.S. Application Data
(60) Provisional application No. 61/297,987, filed on Jan. 25, 2010.

(51) Int. Cl. A01G 9/02; B05B 15/00

(52) U.S. Cl. 47/66.7; 47/79; 239/542

(57) ABSTRACT

A device and method are provided for growing an array of plants. In an embodiment, the device includes a containment membrane positionable in surrounding relation to an array of plant root systems. A plant growing medium can be positioned in an interior of the membrane into which the plant roots can grow. Portions of top edges of the membrane can be sealed, leaving apertures through which a plant stem can project upward. A fluid delivery tube can extend along and within the membrane interior. The tube can comprise a drip tube such as known in the art, or can be adapted for delivering fluid to the plant roots “on demand.”

### CROSS-REFERENCE TO RELATED APPLICATION

This application claims priority to provisional patent application Ser. No. 61/297,987, filed Jan. 25, 2010.

### TECHNOLOGICAL FIELD

The technological field generally relates to apparatus and methods for growing plants.

### BACKGROUND

In regions where water is scarce, and as water becomes scarce in other regions, highly efficient irrigation and fertigation systems that use a minimum of water and fertilizers become increasingly important. A highly efficient irrigation system comprises a porous membrane operating under low pressure (U.S. Pat. No. 7,198,431, co-owned with the present application, the contents of which are incorporated hereinto by reference). This disclosure is directed to a system and method for efficiently delivering an aqueous solution to plants that includes a hydrophilic delivery device, for example, tubing, that has a portion downstream from a source of the aqueous solution that is positionable adjacent a root system of a plant and a lumen for channeling an aqueous solution from an inlet to the downstream portion. At least a portion of the device's wall along the downstream portion has a porosity adapted for permitting a flow of the aqueous solution therethrough when acted upon by a surfactant root exudate and/or negative pressure generated by the roots due to the approach of water stress. The system further comprises a reservoir that is adapted for holding the aqueous solution therein and is situated in fluid communication with the hydrophilic device's inlet.

Another problem with currently used irrigation systems is the accumulation of salts in an irrigation zone. These salts accumulate from several sources, as illustrated in FIG. 1. One source is from excessive irrigation with water having salts therein. The salts accumulate around the plants' root systems both from water used by the plants and also via surface evaporation of water not used by the plants.

Salts can also accumulate from the capillary rise of water from the water table, when the water table is high, as in the case of over-irrigation. Further, salt can accumulate from runoff from higher elevations. Flushing the root zone can temporarily ameliorate the problem, but of course the salts that are flushed downward ultimately reach the water table, and the cycle begins again.

Therefore, it would be desirable to provide a plant growing system that is both highly efficient and that substantially prevents, or at least significantly reduces, salt accumulation adjacent the plant root zone.

### SUMMARY

A device and method are provided for growing an array of plants. In an embodiment, the device comprises a membrane positionable in surrounding relation to an array of plant root systems. A plant growing medium can be positioned in an interior space defined by the membrane into which the plant roots can grow. The words “growing medium” is intended to be construed broadly, and growing medium for use with the present invention can comprise any material adapted for supporting root structures and into which roots can grow. Thus the growing medium can comprise a soil in some cases, or in other cases a non-organic material.

A plurality of substantially longitudinally arrayed, spaced-apart apertures extend through a top portion of the membrane. In some instances, portions of top edges of the membrane can be joined together at spaced-apart intervals, leaving apertures therebetween through which a plant stem can project upward.

A fluid delivery tube can extend at least partially along and within the membrane interior. The tube can comprise a drip tube such as known in the art, or can be adapted for delivering fluid to the plant roots “on demand,” as discussed in the aforementioned '431 patent.

### BRIEF DESCRIPTION OF THE DRAWING

FIG. 1 (prior art) is a vertical cross-sectional view of a growing plant and exemplary sources of salt accumulation adjacent the plant's root zone.

FIG. 2 is a side cross-sectional view of a containment membrane for use with the present invention.

FIG. 3 is a top/side cut-away view of a first embodiment of a containment system for growing plants.

FIG. 4 is a top/side cut-away view of a second embodiment of a containment system for growing plants, in this embodiment for use in a surface installation.

FIG. 5 is a top/side cut-away view of a third embodiment of a containment system for growing plants.

FIG. 6 is a top/side cut-away view of a fourth embodiment of a containment system for growing plants.

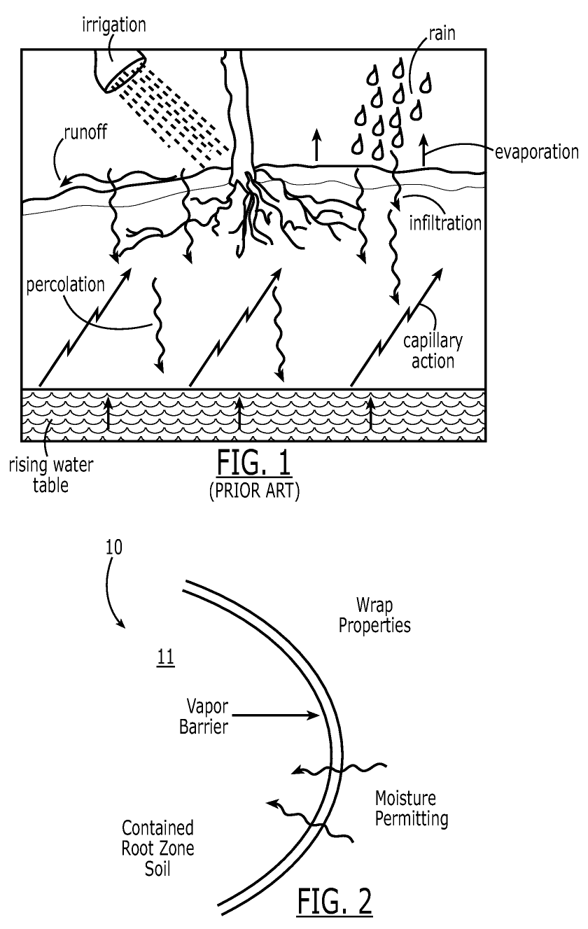

### DETAILED DESCRIPTION OF PREFERRED EMBODIMENTS

A system and method for fluid delivery to a contained plant will now be presented with reference to FIGS. 2-6.

As used herein, the words “tubes” or “tubing” refer to supply lines for providing fluids to a target plant array. As will be appreciated by one of skill in the art, such “tubes” or “tubing” do not necessarily need to be cylindrical, but may be of any suitable shape, and no limitation is intended by the use of these words.

The systems and methods of the present invention contain the roots of a plant growing in a growth medium contained within an interior of a membrane positioned in surrounding relation to the plant. Portions of top edges of the membrane can be sealed, leaving apertures through which a plant stem can project upward.

A membrane 10 (FIG. 2) usable with the present invention preferably is adapted to act as a vapor barrier from an interior 11 thereof and to permit moisture to enter the interior 11 from external the membrane 10. Alternatively, the membrane 10 can be fluid-impervious.

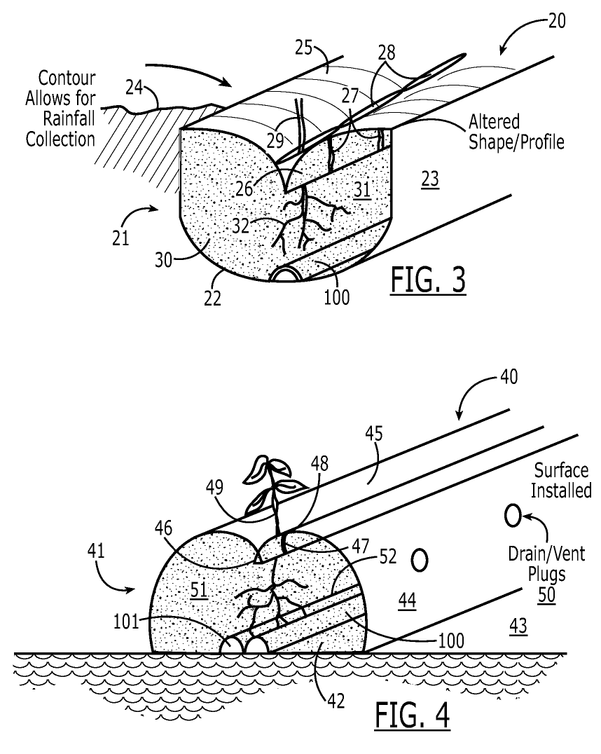

In a first embodiment (FIG. 3), a plant containment device 20 comprises a membrane 21 having bottom 22 and sides 23 in a substantially “U” shape positionable beneath the ground surface 24. A top portion comprises opposed membrane sections 25 extending downwardly to a flap 26 having spaced-apart sealed portions 27, formed, for example, by spot welding, defining apertures 28 through each of which a plant stem 29 can extend. The membrane interior 30 contains growing medium 31. The growing medium 31 can comprise dirt, although this is not a necessity, since all materials required for sustaining growth can be supplied within the membrane 21. The growing medium 31 should be of sufficient structure to support the root system 32, allowing the plant to stand upright.

In a second embodiment (FIG. 4), adapted for surface installation, a plant containment device 40 comprises a membrane 41 having a bottom 42 positionable atop a surface 43. Opposed sides 44 extend upwardly from the bottom 42. A top surface comprises opposed membrane portions 45 extending downwardly to a flap 46 having spaced-apart sealed portions 47 defining apertures 48 through each of which a plant stem 49 can extend. The membrane sides 44 can have drain/vent plugs 50 for use as desired. The membrane interior 51 contains growing medium 52.

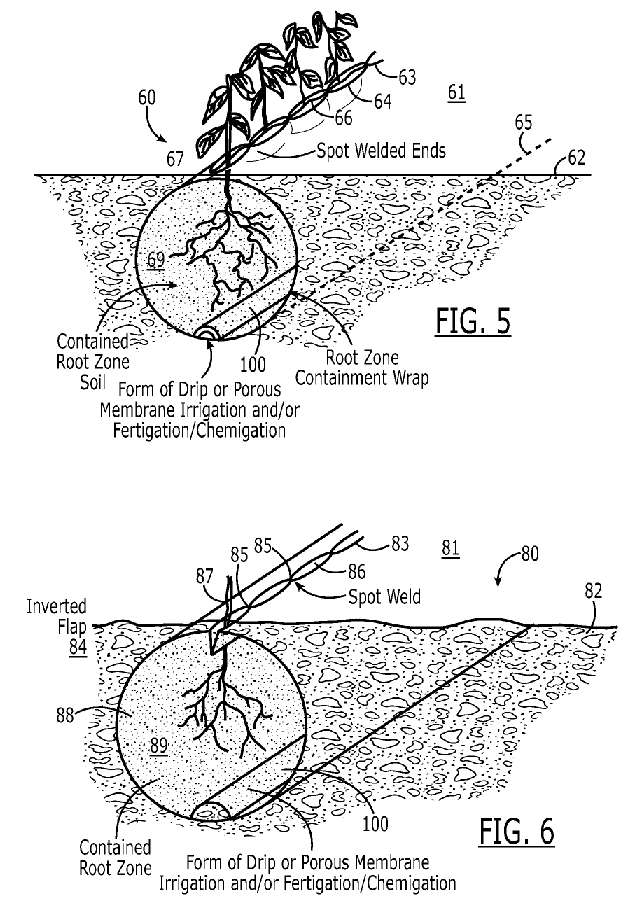

In a third embodiment (FIG. 5), a plant containment device 60 in a particular embodiment comprises a substantially cylindrical membrane 61 positionable beneath the ground surface 62. One of skill in the art will appreciate that such a structure does not need to be cylindrical, and that substantially any enveloping structure is intended to be subsumed in the present invention. Opposed top edges 63 of the membrane 61 extend upwardly to a flap 64 having spaced-apart sealed portions 65 defining apertures 66 through each of which a plant stem 67 can extend. The membrane interior 68 contains growing medium 69.

In a fourth embodiment (FIG. 6), a plant containment device 80 comprises a substantially cylindrical membrane 81 positionable beneath the ground surface 82. Opposed top edges 83 of the membrane 81 extend downwardly to a flap 84 having spaced-apart sealed portions 85 defining apertures 86 through each of which a plant stem 87 can extend. The membrane interior 88 contains growing medium 89.

A fluid delivery tube 100 can extend at least partially through the membrane interiors 30, 51, 68, 88. The tube 100 can comprise a drip tube such as known in the art, or can be adapted for delivering fluid to the plant roots “on demand,” as with the hydrophilic tubing discussed above.

A drain tube 101 (FIG. 4) can also extend at least partially through the membrane interiors 30, 51, 68, 88, for channeling away any excess fluid that may accumulate because of rainfall or flooding, for example.

The tubes 100,101 are connectable to at least one reservoir that contains water, nutrients, biocides, or a mixture or other substance desired to be delivered to the target plants.

The present systems 20, 40, 60, 80 and methods have a multiplicity of benefits. First, fluid is delivered in a highly efficient manner, thereby saving water, fertilizer, and any other element desired to be delivered. Evaporative loss is minimized, since the fluid and membrane interiors 30, 51, 68, 88 are not exposed to the air. Salt accumulation is also decreased, and what salt that does accumulate is not channeled to the water table. Additionally, the systems 20, 40, 60, 80 are reusable any number of times, thereby conserving materials, as opposed to the present single-use ground cover systems. Additionally, like the ground cover systems, nutrient and water-stealing weeds are prevented by the containment membrane. The containment membranes, which can be of various types, can be installed with a machine that lays down the membrane, adds growing medium, and seals the top edges. Substantially any shape can be accommodated so long as the plant's root structure is contained. Pest infiltration is reduced, as there is substantially no contact with surrounding soil.

What is claimed is:

1. A device for growing an array of plants comprising:
a containment membrane having a substantially cylindrical shape and defining an interior space therewithin, the interior space adapted to contain a root support medium and root systems of a plurality of plants, a top portion of the membrane having a plurality of substantially longitudinally arrayed, spaced-apart apertures therein adapted for admitting a plant stem therethrough; and
a fluid delivery tube extending at least partially along and within the membrane, the fluid delivery tube adapted for releasing fluid from an interior thereof into the membrane inner space.

2. The device recited in claim 1, wherein:
the membrane comprises a substantially “U”-shaped portion forming the bottom portion and upwardly extending sides of the membrane, at least part of the “U”-shaped portion adapted for below-surface installation; and
the top portion comprises a pair of opposed membrane sections having outer edges meeting the sides at a top edge thereof, the opposed top sections sloping downwardly from the outer edges and meeting at respective opposed inner edges, the inner edges joined together at spaced-apart sealed portions to define the apertures.

3. The device recited in claim 2, wherein the sealed portions of the top portions form a downwardly extending flap through which the apertures extend substantially vertically.

4. The device recited in claim 1, wherein the membrane is formed from a substantially planar sheet, and the top portion comprises opposed edges of the sheet joined together at spaced-apart sealed portions to define the apertures.

5. The device recited in claim 4, wherein the sealed portions form a downwardly extending flap through which the apertures extend substantially vertically.

6. The device recited in claim 5, wherein the membrane is adapted for surface installation, and the membrane further has a plurality of vents therethrough along sides thereof.

7. The device recited in claim 4, wherein the sealed portions form an upwardly extending flap through which the apertures extend substantially vertically.

8. The device recited in claim 4, wherein at least a portion of the membrane is adapted for below-surface installation, the upwardly extending flap at least partially above surface.

9. The device recited in claim 1, wherein the fluid delivery tube comprises a drip tube.

10. The device recited in claim 1, wherein the fluid delivery tube comprises a membrane adapted for fluid delivery when acted upon by at least one of plant root exudate and negative root pressure.

11. The device recited in claim 1, further comprising a drain tube extending adjacent a bottom portion of the membrane, the drain tube adapted for channeling excess fluid from the membrane inner space.

12. A method for growing an array of plants comprising:
placing a root support medium within a containment membrane having a substantially cylindrical shape and defining an interior space therewithin;
planting root systems of a plurality of plants in the root support medium, each plant stem of the plants extending through one of a plurality of substantially arrayed, spaced-apart apertures in a top portion of the membrane; and
delivering fluid to the root systems using a fluid delivery tube extending at least partially along and within the membrane, the fluid delivery tube adapted for releasing fluid from an interior thereof into the membrane inner space.

13. The method recited in claim 12, further comprising positioning at least part of the membrane below a ground surface, and wherein:
the membrane comprises a substantially “U”-shaped portion forming the bottom portion and upwardly extending sides of the membrane; and
the top portion comprises a pair of opposed membrane sections having outer edges meeting the sides at a top edge thereof, the opposed top sections sloping downwardly from the outer edges and meeting at respective opposed inner edges, the inner edges joined together at spaced-apart sealed portions to define the apertures.

14. The method recited in claim 13, wherein the sealed portions of the top portions form a downwardly extending flap through which the aperture extends substantially vertically.

15. The method recited in claim 12, wherein the membrane is formed from a substantially planar sheet, and the top portion comprises opposed edges of the sheet joined together at spaced-apart sealed portions to define the apertures.

16. The method recited in claim 15, wherein the sealed portions form a downwardly extending flap through which the apertures extend substantially vertically.

17. The method recited in claim 16, further comprising positioning the membrane atop a ground surface, and wherein the membrane further has a plurality of vents therethrough along sides thereof.

18. The method recited in claim 15, wherein the sealed portions form an upwardly extending flap through which the apertures extend substantially vertically.

19. The method recited in claim 15, further comprising positioning at least a portion of the membrane below a ground surface, the upwardly extending flap at least partially above surface.

20. The method recited in claim 12, wherein the fluid delivery tube comprises a drip tube.

21. The method recited in claim 12, wherein the fluid delivery tube comprises a membrane adapted for fluid delivery when acted upon by at least one of plant root exudate and negative root pressure.

22. The method recited in claim 12, further comprising channeling excess fluid from the membrane inner space with the use of a drain tube extending adjacent a bottom portion of the membrane.
